(19) United States
(12) Patent Application Publication
(10) Pub. No.: US 2004/0230725 A1
(43) Pub. Date: Nov. 18, 2004

(54) Audio/video device

(75) Inventors: Yu-Hsin Chen, Taipei Hsien (TW); Jhao-Ming Wang, Taipei Hsien (TW)

Correspondence Address: QUINTERO LAW OFFICE, 1617 BROADWAY, 3RD FLOOR, SANTA MONICA, CA, 90404, US

(73) Assignee: Wistron Corporation

(21) Appl. No.: 10/653,731

(22) Filed: Sep. 2, 2003

(30) Foreign Application Priority Data
May 12, 2003 (TW) 92112786

(51) Int. Cl. G06F 3/00

(52) U.S. Cl. 710/72

(57) ABSTRACT

An audio/video device. A tablet PC has a first input/output unit and a first connecting port. A host has a seat for receiving the tablet PC, a second input/output unit, and a second connecting port connected to the second input/output unit. The first connecting port is connected to the second connecting port when the first electronic assembly is disposed in the seat, such that the host is connected to the tablet PC, and data, such as audio and/or video, can be transmitted between the tablet PC and the host.

### BACKGROUND OF THE INVENTION

1. Field of the Invention

The present invention relates to an audio/video device, and in particular to an audio/video device provided with a tablet PC detachably connected to and communicated with a host.

2. Description of the Related Art

Electronic products, such as tablet PC, mobile phone, Personal Digital Assistant (PDA), notebook, etc., are usually provided with a battery charger, a cradle, or the like. However, beyond charging, the battery charger simply functions as an abutment or supporter holding the corresponding product thereon.

When data is downloaded from, uploaded to, or output by the electronic device, it is necessary to provide another device for connection. This causes inconvenience by requiring a separate unit.

Some cradles of PDA also functioned as data communication interface between a PDA and a computer. Docking station for notebook computers may also contain extra storage devices and outputting devices like audio speakers. Nevertheless, user can neither input information nor receive information directly from the cradle or docking station itself.

### SUMMARY OF THE INVENTION

Accordingly, an object of the invention is to provide an audio/video device for a tablet PC that the Tablet PC and the host (the audio/video device) are detachably connected, such that data can be transmitted therebetween.

Another object of the invention is to provide a audio/video device comprising a tablet PC and an audio host wherein the audio host has a signal processing unit. Thus the audio host can play audio data stored on a carrier like audio-CD even if the tablet PC is not connected to the audio host.

The invention provides an audio/video device having a first electronic assembly and a second electronic assembly. The first electronic a has a first input/output unit and a first connecting port. The second electronic assembly has a seat for receiving the first electronic assembly, a second input/output unit, a second connecting port and a processing unit connected to the second input/output unit and the second connecting port. Thus, data can be transmitted between the first connecting port and the second connecting port, i.e., data can be transmitted between the first electronic assembly and the second electronic assembly. Without the connection of the first electronic assembly, the second electronic assembly can function as an audio device to directly output data.

Another aspect of the invention provides an expandable audio/video device with a removable storage unit, such as optical disc driver, floppy disc driver, hard disk, etc., on the second electronic assembly, such that data from the first electronic assembly can be stored on the storage unit.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view of an audio/video device (E1) according to a first embodiment of the present invention;

FIG. 2 is an exploded view of the audio/video device (E1) in FIG. 1;

FIG. 3 shows another view of the audio/video device (E1) in FIG. 1;

FIG. 4 is a perspective view of an audio/video device (E2) according to a second embodiment of the present invention;

FIG. 5A is a perspective view of an audio/video device (E3) according to a third embodiment of the present invention; and

FIG. 5B is an exploded view of the audio/video device (E3) in FIG. 5.

### DETAILED DESCRIPTION OF THE INVENTION

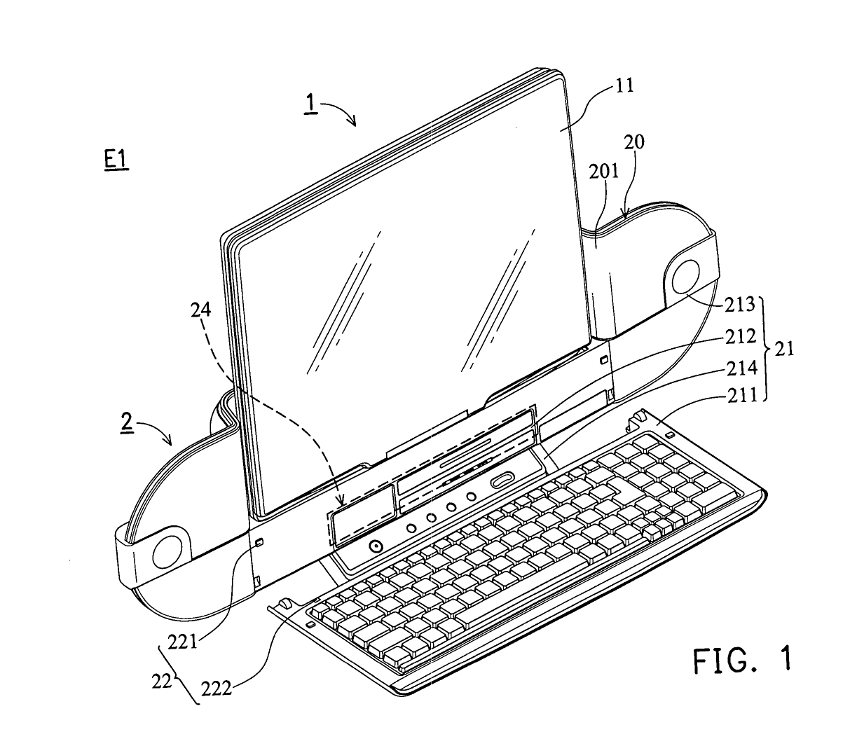

In FIG. 1, E1 is the audio/video device of a first embodiment of the invention. The audio/video device E1 comprises a first electronic assembly 1 and a second electronic assembly 2. The first electronic assembly 1 is an electronic device, such as a tablet PC or a video display device, capable of outputting images. The second electronic assembly 2 is a host functioning as a docking station for the first electronic assembly 1.

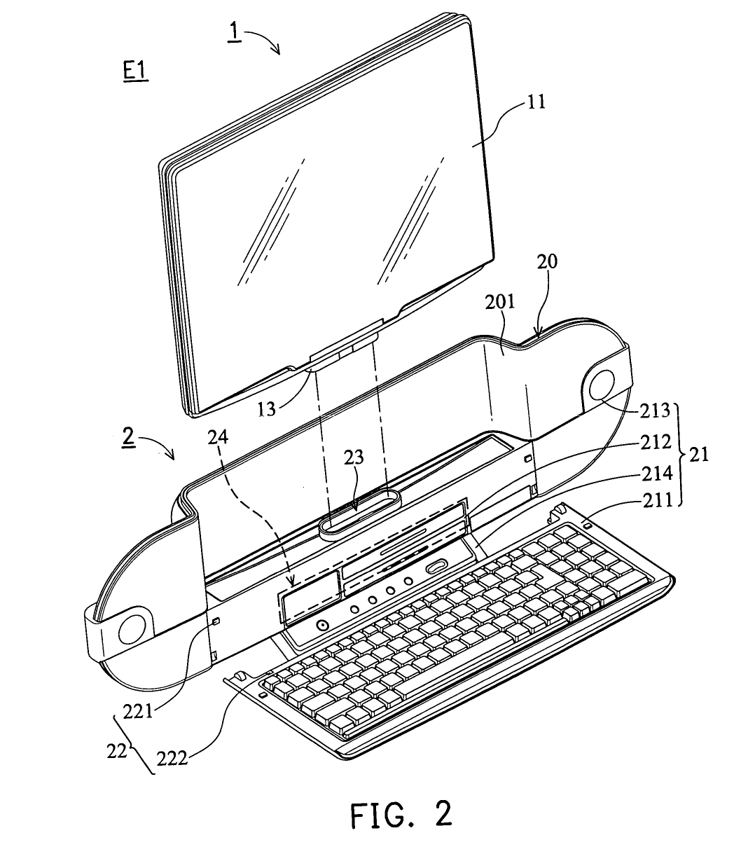

Referring to FIG. 2, the first electronic assembly 1 includes a first input/output unit 11 and a first connecting port 13. The first connecting port 13 is disposed on one side of the first electronic assemble 1 and is electrically connected to a circuit unit (not shown) within the first electronic assembly 1. For this embodiment, the first input/output device 11 is a panel structure through which a user can input data into the first electronic assembly 1 or the first electronic assembly 1 can display the data. It is to be noted that the first electronic assembly 1 is a tablet PC in this embodiment. However, the first electronic assembly can also be other device having display function, such as a LCD display panel.

The second electronic assembly 2 comprises a body 20, a second input/output unit 21, a positioning device 22, a second connecting port 23 and a signal processing unit 24. The second input/output unit 21 and the second connecting port 23 are connected to the signal processing unit 24 such that data from the second input/output unit 21 and the second connecting port 23 can be processed by the signal processing unit 24, or data processed by the signal processing unit 24 can be transmitted or output through the second input/output unit 21 and the second connecting port 23.

A seat 201 is formed on the body 20 for receiving the electronic device 1. The second connecting port 23 is located at the bottom of the seat 201, connecting the first connecting port 13 of the first electronic assembly 1. When the first electronic assembly 1 is received in the seat 201 of the second electronic assembly 2, the second connecting port 23 is connected to the first connecting port 13 (See FIG. 1).

The input/output unit 21 has a keyboard 211, a detachable storage unit 212, an audio unit 213 and a control unit 214. The second electronic assembly 2 can be controlled by the keyboard 211 or the control buttons integrated with the control unit 214, and the related data is transmitted to and stored in the storage unit 212. The storage unit 212 can be a floppy, hard disk, optical disc or the like. The sound unit 213, such as a speaker, is disposed on the body 20 and outputs audio data from the signal processing unit 24. The control unit 214 is connected to a transmitter/receiver (not shown) of the keyboard 211, the storage unit 212 and the sound unit 213, such that the working status of the keyboard 211, the storage unit 212 and the sound unit 213 can be observed.

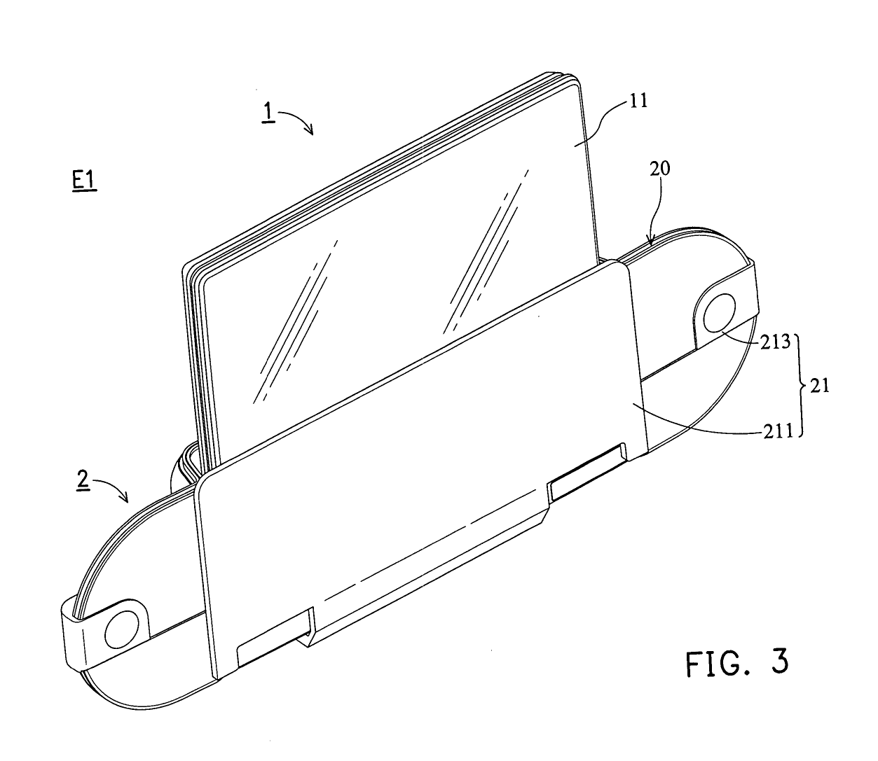

The positioning device 22 has two parts 221, 222 disposed on the body 20 and the keyboard 211, respectively. As shown in FIG. 3, the keyboard 211 is attached to the body 20 by parts 221, 222 together. The parts 221, 222 can be the magnetic plates or switches with opposite polarities.

When the first electronic assembly 1 is disposed in the seat 201 and electronically connected to the second electronic assembly 2 via connection of the first connecting port 13 and second connecting port 23, the first electronic assembly 1 can be controlled by the keyboard 211 and the control unit 214. That is to say, data can be easily transmitted between the first electronic assembly 1 and second electronic assembly 2, and data from the first electronic assembly 1 can be directly output by the second electronic assembly 2.

For example, data, such as audio signal, of the first electronic assembly 1 can be output by the sound unit 213. Also data from the second electronic assembly 2, such as video signal, can be output by the first input/output unit 11.

It is a possible operation mode that there is no data transfer between the first electronic assembly 1 and second electronic assembly 2 when the two electronic assemblies are connected together. Under this mode the user can listen to the sound output by the second electronic assembly 2 without affecting the performance of the first electronic assembly 1. It is also another possible operation mode that only electric power and the keyboard signal of the second electronic assembly 2 are transferred through the second connecting port 23 and the first connecting ports 13 to the first electronic assembly 1, while the second electronic assembly 2 is independently controlled by certain bottoms on the control unit 214.

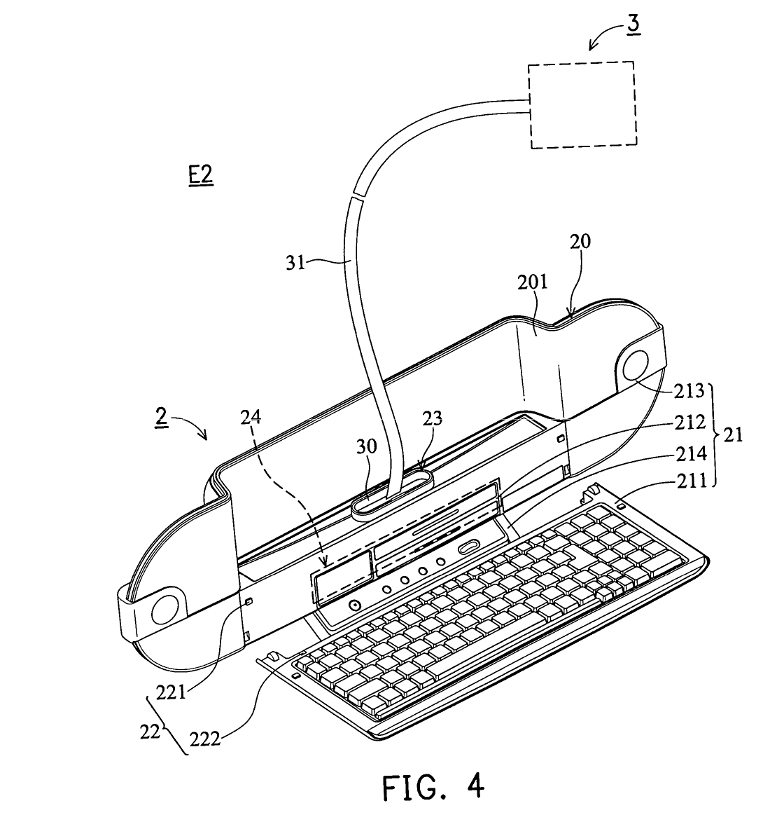

In FIG. 4, E2 is an audio/video device of a second embodiment of the invention. The audio/video device E2 differs from the first embodiment in that a connector 30 connected to an external electronic device 3, such as a Personal Digital Assistant (PDA), is mounted on the second connecting port 23 of the second electronic assembly 2, and can function in the same data transfer operations as in the first embodiment.

When disconnected from external electronic device 3, the second electronic assembly 2 can independently function as an audio device, i.e., audio data processed by the signal processing unit 24 can be directly output by external electronic device 3.

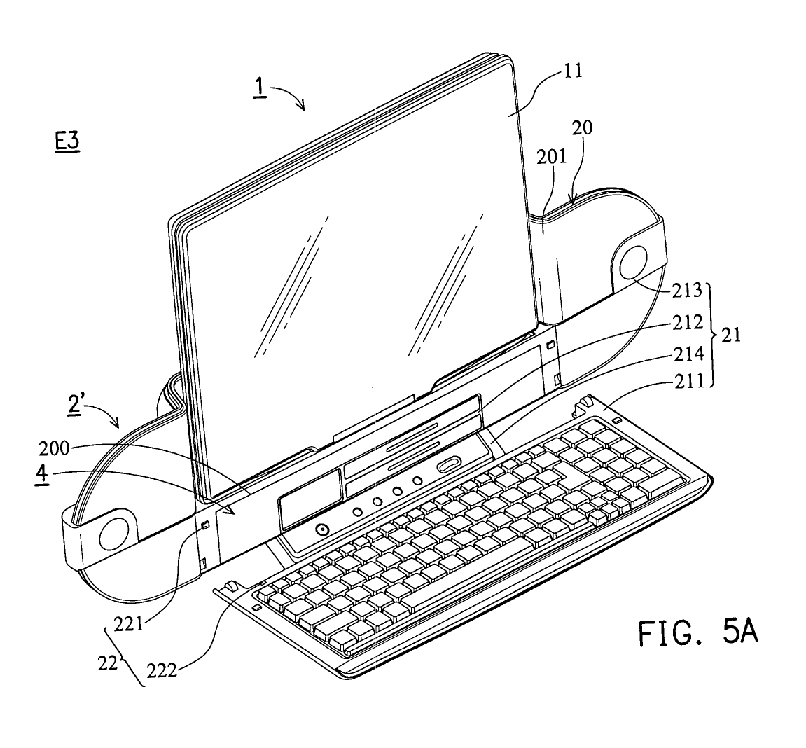

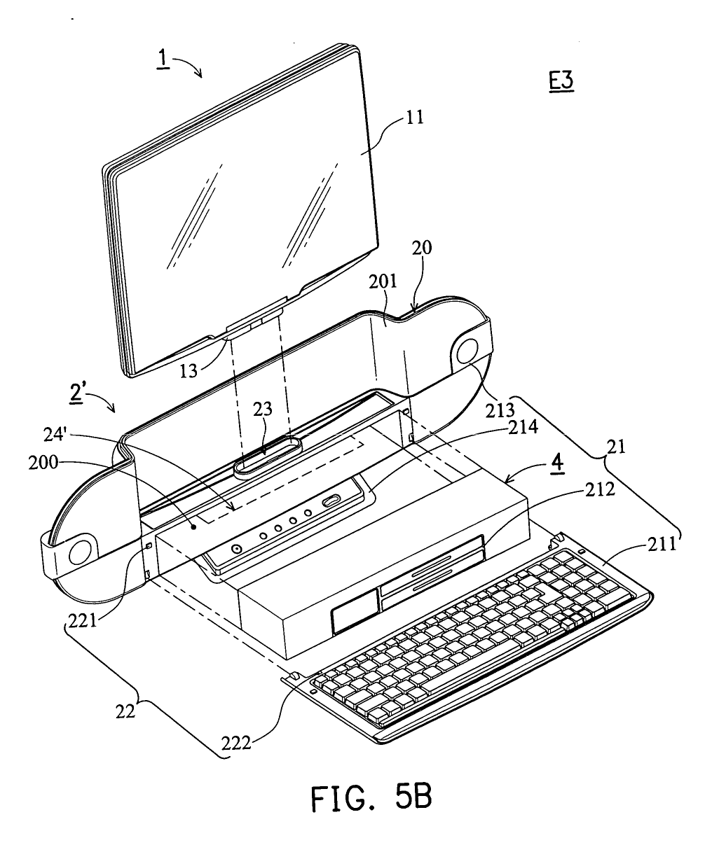

In FIGS. 5A and 5B, E3 is an audio/video device of a third embodiment of the invention. The audio/video device E3 differs from that of the first embodiment in that a receiving space 200 is formed on a second electronic assembly 2′, a signal processing unit 24′ is disposed in the receiving space 200, and a removable modular device 4 is provided for the installation of the storage unit 212 and received in the receiving space 200.

When the modular device 4 enclosing the storage unit 212 is disposed in the receiving space 200, the storage unit 212 is connected to the signal processing unit 24′, such that data from the first electronic assembly 1 can be stored in the storage unit 212. That is to say, data can be transmitted between the first electronic assembly 1 and the second electronic assembly 2′, and data, such as audio and video, from the first electronic assembly 1 can be output by the second electronic assembly 2′.

While this invention has been described in connection with what is presently considered to be the most practical and preferred embodiment, it is to be understood that the invention is not limited to the disclosed embodiments, but, on the contrary, is intended to enclose various modifications and equivalent arrangements included within the spirit and scope of the appended claims. For example, the invention can also includes a cooling device to channel out the heat produced by both the electronic assembly 1 and electronic assembly 2, thus the electronic assembly 1 can be operated in a higher operation frequency.

What is claimed is:

1. A device for connecting to an external electronic device provided with a first connecting port to transmit data, comprising:
a host having a seat for receiving the electronic device, an input/output unit and a second connecting port connected to the input/output unit, connecting the first connecting port, such that data is transmitted between the electronic device and the host as well as input or output by the input/output unit.

2. The device as claimed in claim 1, wherein the first connecting port is connected to the second connecting port when the external electronic device is disposed in the seat.

3. The device as claimed in claim 1, wherein the host has a keyboard connected to the second connecting port.

4. The device as claimed in claim 1, wherein the host has a storage unit connected to the second connecting port.

5. The device as claimed in claim 1, wherein the host has a storage unit detachably connected to the second connecting port.

6. The device as claimed in claim 1, wherein the host has an audio unit connected to the second connecting port.

7. The device as claimed in claim 1, wherein the host has a control unit connected to the second connecting port.

8. A device for transmitting data, comprising:
a tablet PC having a first input/output unit and a first connecting port, for transmitting data; and
a host having a seat for receiving the electronic device, a second input/output unit and a second connecting port connected to the second input/output unit, connecting the first connecting port, such that the host is connected to the tablet PC and data transmitted between the tablet PC and the host is input or output by the second input/output unit.

9. The device as claimed in claim 8, wherein the first connecting port is connected to the second connecting port when the tablet PC is disposed in the seat.

10. The device as claimed in claim 8, wherein the host has a keyboard connected to the second connecting port.

11. The device as claimed in claim 8, wherein the host has a storage unit connected to the second connecting port.

12. The device as claimed in claim 8, wherein the host has a storage unit detachably connected to the second connecting port.

13. The device as claimed in claim 8, wherein the host has a control unit connected to the second connecting port.

14. A device for transmitting data, comprising:
a first electronic assembly having a first input/output unit and a first connecting port, for transmitting data; and
a second electronic assembly having a second input/output unit, a second connecting port and a processor connected to the second input/output unit and the second connecting port, such that data is transmitted between the first connecting port and the second connecting port.

15. The device as claimed in claim 14, wherein the second electronic assembly has a seat for receiving the first electronic assembly.

16. The device as claimed in claim 14, wherein the second electronic assembly has a seat for receiving the first electronic assembly, and the first connecting port is connected to the second connecting port when the first electronic assembly is disposed in the seat.

17. The device as claimed in claim 14, wherein the first electronic assembly is a tablet PC.

18. The device as claimed in claim 14, wherein the second electronic assembly has a keyboard connected to the second connecting port.

19. The device as claimed in claim 14, wherein the second electronic assembly has a storage unit connected to the second connecting port.

20. The device as claimed in claim 14, wherein the second electronic assembly has a storage unit detachably connected to the second connecting port.

21. The device as claimed in claim 14, wherein the second electronic assembly has an audio unit connected to the second connecting port.

22. The device as claimed in claim 14, wherein the second electronic assembly has a control unit connected to the second connecting port.

23. A device for transmitting data, comprising:
a first electronic assembly having a first input/output unit and a first connecting port, for transmitting data;
a second electronic assembly having a receiving space, a second input/output unit, a second connecting port and a processor connected to the second input/output unit and the second connecting port, such that data is transmitted between the first connecting port and the second connecting port; and
a modular device detachably disposed in the receiving space, connecting the second input/output unit to the second connecting port.

24. The device as claimed in claim 23, wherein the second electronic assembly has a seat for receiving the first electronic assembly.

25. The device as claimed in claim 23, wherein the second electronic assembly has a seat for receiving the first electronic assembly, and the first connecting port is connected to the second connecting port when the first electronic assembly is disposed in the seat.

26. The device as claimed in claim 23, wherein the first electronic assembly is a tablet PC.

27. The device as claimed in claim 23, wherein the second electronic assembly has a keyboard connected to the second connecting port.

28. The device as claimed in claim 23, wherein the second electronic assembly has a storage unit connected to the second connecting port.

29. The device as claimed in claim 23, wherein the second electronic assembly has a storage unit detachably connected to the second connecting port.

30. The device as claimed in claim 23, wherein the second electronic assembly has an audio unit connected to the second connecting port.

31. The device as claimed in claim 23, wherein the second electronic assembly has a control unit connected to the second connecting port.

32. An electronic system, comprising:
a first electronic assembly having a first output device and a first connecting unit; and
a second electronic assembly having a second output B device, a second input device, and a second connecting unit,
wherein said first electronic assembly is detachably connected to said second electronic assembly through connection of said first connecting unit and said second connecting unit, thereby data and control signal from said second electronic assembly is transmitted to said first electronic assembly.

33. The system of claim 32, wherein said first output device is a display unit for outputting video data, and said second output device is a voice unit for outputting audio data.

34. The system of claim 33, wherein said second electronic assembly further comprises a data retrieving device connected to said second signal processing unit for retrieving data from a data carrier.

35. The system of claim 34, wherein said second electronic assembly further comprises a second signal processing unit for processing data inputted from said second input device or said data retrieving device.

36. The system of claim 35, wherein said second electronic assembly further includes a recess for receiving said first electronic assembly and said first connecting unit is disposed within said recess.

37. The system of claim 36, wherein said first electronic assembly further comprises a first input device for inputting data, a first storage device for storing data, and a first central processing unit for processing data came from said first input device, said first storage device or said second electronic assembly.

38. The system of claim 37, herein the first output device and the first input device is integrated in a touch-screen display panel.

39. The system of claim 32, wherein said second electronic assembly further comprises a data retrieving device connected to said second signal processing unit for retrieving data from a data carrier.

40. The system of claim 39, wherein said second electronic assembly further comprises a second signal processing unit for processing data inputted from said second input device or said data retrieving device.

41. The system of claim 40, wherein said second electronic assembly further includes a recess for receiving said first electronic assembly and wherein said first connecting unit is disposed within said recess.
